(19) United States
(12) Patent Application Publication
(10) Pub. No.: US 2015/0381977 A1
(43) Pub. Date: Dec. 31, 2015

(54) ARRAY SUBSTRATE AND DISPLAY DEVICE

(71) Applicants: Boe Technology Group Co., Ltd., Beijing (CN); Beijing Boe Display Technology Co., Ltd., Beijing (CN)

(72) Inventors: Bo Feng, Beijing (CN); Yu Ma, Beijing (CN); Xiao Wang, Beijing (CN); Yan Yan, Beijing (CN)

(21) Appl. No.: 14/477,979

(22) Filed: Sep. 5, 2014

(30) Foreign Application Priority Data
Jun. 25, 2014 (CN) 201410291426.7

(51) Int. Cl. H04N 17/00

(52) U.S. Cl. CPC H04N 17/004

(57) ABSTRACT

The present disclosure relates to an array substrate and display device. The array substrate comprises a packaged region covered by a package, a non-packaged region other than the packaged region, and a test unit arranged within the non-packaged region, wherein the test unit is connected to a test point. The disclosure can be used in the manufacture of display panels.

### FIELD OF THE DISCLOSURE

The present disclosure relates to the field of liquid crystal display panel manufacturing techniques, and particularly to an array substrate and display device.

### BACKGROUND OF THE DISCLOSURE

At present, to test the signal of signal lines in a gate driver on array (GOA) unit or the display region of an array substrate on a display panel generally involves: arranging test units such as test pads on the array substrate, and the corresponding data from the test points is tested by a testing instrument with the probes thereof touching the test pads. Since the test pads are generally within the packaged region of the panel, the substrate needs to be cut in testing to expose the test pads, so that the test pads can be touched by the probes and thus the test to the test points is enabled.

However, such a design is somewhat troublesome in practical operation that a timely and rapid test cannot be achieved. Moreover, the display panel after being cut cannot be utilized any more for displaying and therefore resulting in a waste of products.

### SUMMARY OF THE DISCLOSURE

According to a first aspect of the present disclosure, an array substrate is provided comprising:

a packaged region covered by a package;

a non-packaged region other than the packaged region; and

a test unit arranged within the non-packaged region, wherein the test unit is connected to a test point.

According to a second aspect of the present disclosure, a display panel is provided comprising the array substrate of the first aspect.

The array substrate and display panel provided by the embodiments of the present disclosure allow the probes of the testing instrument to be placed directly at the test unit to perform a test by arranging the test unit at any empty location within the non-packaged region of the array substrate, without drilling a hole in the packaged region; thereby solving the problem that the existing test process is time-consuming and cumbersome in operation and avoiding a unnecessary waste of products, thus resulting a reduced production cost.

### BRIEF DESCRIPTION OF DRAWINGS

These and other aspects of the disclosure are described in more detail with reference to the appended drawings illustrating the embodiments of the disclosure.

FIG. 1 is a schematic diagram of the structure of an array substrate according to an embodiment of the disclosure;

FIG. 2 is a schematic diagram of the structure of another array substrate according to an embodiment of the disclosure;

FIG. 3 is a schematic diagram of the structure of yet another array substrate according to an embodiment of the disclosure;

FIG. 4 is a schematic diagram of the structure connecting a GOA unit to an ITO layer in an array substrate according to an embodiment of the disclosure.

### DETAILED DESCRIPTION OF PREFERRED EMBODIMENTS

By way of examples, the non-limiting embodiments of the disclosure will be described now in detail with reference to the drawings.

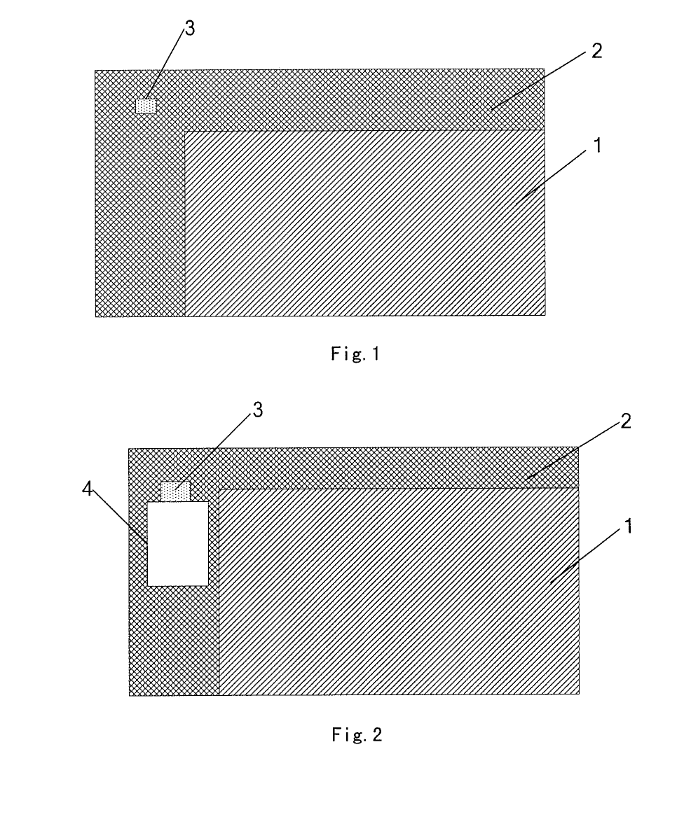

FIG. 1 is a schematic diagram of the structure of an array substrate according to an embodiment of the disclosure. Referring to FIG. 1 (only one corner of an array substrate is shown), the array substrate comprises a packaged region 1, a non-packaged region 2 and a test unit 3, wherein the packaged region 1 is the region that is covered by a package on the array substrate, the non-packaged region 2 is the region other than the packaged region 1 on the array substrate, and the test unit 3 is arranged within the non-packaged region 2 and is connected to a test point.

When a test is performed, the signal from the test point can be tested by a testing instrument with the probes thereof touching the test unit 3, and thus the monitoring of the performance of the array substrate or display device is enabled. In the embodiments of the disclosure, the test unit 3 is arranged at any empty location within the non-packaged region of the array substrate, without affecting the forming of other structures in the array substrate. In addition, one or more test units 3 may be arranged within the non-packaged region, depending on the number of the test points to be tested.

It should be noted that in the embodiments of the disclosure the array substrate may be an array substrate in a liquid crystal display panel or the one in an organic light emitting diode (OLED) panel. In the manufacturing process, as a first substrate, the array substrate is cell-aligned with a second substrate to form a display panel. After the cell-alignment, the region covered by the second substrate on the array substrate is the packaged region. Herein the second substrate may be a color filter substrate or packaging substrate or any other type of substrate.

The test unit 3 may be made of transparent conductive materials. For example, the transparent conductive materials may be indium tin oxide (ITO), which is also the material forming the pixel electrode layer. The test unit 3 may be formed in the same layer as the ITO pixel electrode layer of the array substrate. In the case that the array substrate comprises two or more transparent conductive film layers, the test unit 3 may be formed in the same layer as the transparent conductive film layer that is the most upper layer (i.e. closest to the light emergent side) of the array substrate. Alternatively, if the layer at which the test unit 3 is located is not the most upper layer of the array substrate, for the purpose of facilitating the probes of the testing instrument to touch the test unit 3, a via can be drilled above the test unit 3 so as to expose the test unit 3.

In the embodiments of the disclosure, the test unit 3 may be immediately adjacent to the test point, or may be connected to the test point through an electrical wire, depending on the specific location of the test point. Further, in the case that the test point and the test unit 3 are located at different layers, they may be connected through a via or both a via and an electrical wire. Optionally, the via may be located either at the test unit or at the test point.

The embodiments of the disclosure are illustrated hereinafter taking the array substrate with a drive unit for example, wherein the drive unit may be a GOA unit or a unit comprising other type of drive components for driving pixel units.

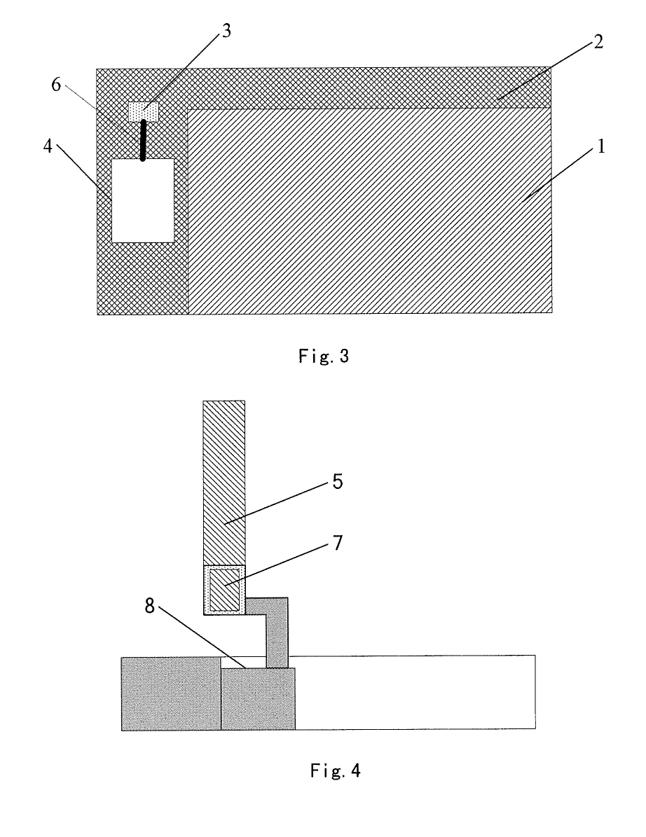

In the case shown in FIG. 2, the test unit 3 is immediately adjacent to the test point of the drive unit 4. In another case, the test unit 3 is connected to the drive unit 4 through an electrical wire 6, as shown in FIG. 3, wherein the electrical wire 6 between the test unit 3 and the drive unit 4 may be of the same material as the test unit 3. Optionally, the electrical wire 6 may be of the same material as the test point of the drive unit 4, or the test unit 3, the electrical wire 6 and the drive unit 4 together may be of the same material.

It is appreciated that a via needs to be drilled in order to connect the test unit 3 to the drive unit 4 when the test unit 3 and the drive unit 4 are located at different layers.

Now referring to FIG. 4, it is assumed that the test unit (not shown) is located at the ITO layer and the drive unit is specifically a GOA unit 8, the test unit is then connected to the test point of the GOA unit 8 through an ITO lead 5 (i.e., an electrical wire) and a via 7, so that the testing of the performance of the GOA unit 8 is enabled. Herein the test point of the GOA unit 8 is the end output structure of the GOA 8.

In an embodiment, if the electrical wire between the test unit and the GOA unit 8 is not in the ITO layer, this electrical wire may be of the same shape as the ITO lead 5 shown in FIG. 4, but of different materials.

Although the via 7 is shown in FIG. 4 as being located at the GOA unit 8, it can also be located at the test unit. In an embodiment, if the test unit is located at the ITO layer, and the test point is located at the source-drain metal layer and is below the test unit, a via in the vertical direction may be arranged so that the test unit above and the test point below can be connected electrically through the via.

Optionally, the test points of the drive unit 4 may comprise a source, a drain, a gate, a gate line and/or a data line. The signal from these objects thus can be tested through the test unit.

By way of example, and not limitation, the test unit may be connected to an electric quantity pulling point of the GOA unit 8 so as to investigate the performance of the GOA unit 8 by testing the electric quantity pulling point. Alternatively, the test unit may be connected to a signal output terminal of the GOA unit 8 so as to investigate the performance of the GOA unit 8 by measuring the latency of the output signal. In practical applications, the test unit may be arranged as required to connect to a specific structure of the GOA unit 8.

Alternatively, the test unit 3 may also be used to investigate the performance of the display region of the array substrate. In this case, the test point is a certain structure in the display region 1 of the array substrate. For example, the test unit 3 may be connected to the test point of the signal line in the display region of the array substrate to test the signal line in the display region 1.

Optionally, the test unit 3 may be connected to the test point of the signal line in the display region 1 through an electrical wire, and the electrical wire may be of the same material as the signal line.

Optionally, the test points of the signal line may comprise a gate, a source, a drain, a gate line, a gate line lead, a data line, and/or combinations thereof. The signal from these objects thus can be tested through the test unit.

It should be noted that in the embodiments of the disclosure the test unit 3 may be connected through a via to the drive unit 4 or the signal line in the display region 1 of the array substrate, wherein the via maybe the via drilled in preparing the signal line layer to allow the signal line layer to be connected to the ITO pixel electrode layer. In addition, in the case that the layer at which the test unit 3 is located is not the most upper layer of the array substrate, the via drilled to expose the test unit 3 is formed in the process where the via in the data line layer or gate line layer of the array substrate is drilled. In other words, the via in the embodiments of the disclosure is formed based on an existing via production procedure, without increasing the production cost.

The embodiment of the disclosure further provides a display device comprising all possible array substrates provided by the embodiments above. The display device may be mobile phone, tablet computer, television, laptop computer, digital photo frame, navigator or any other products or parts with display function.

The foregoing are only the particular embodiments of the present disclosure, but the scope of the disclosure is not limiting to these. Variations and modifications that can be readily thought of by the skilled in the art after having the benefit of the disclosure are included in the scope of the disclosure. Therefore, the scope of the disclosure should be determined by the scope of the appended claims.

1. An array substrate comprising:
a packaged region covered by a package;
a non-packaged region other than the packaged region; and
a test unit arranged within the non-packaged region, wherein the test unit is connected to a test point.

2. The array substrate according to claim 1, wherein the test unit is made of transparent conductive materials.

3. The array substrate according to claim 2, wherein the array substrate comprises two or more transparent conductive film layers and the test unit is formed in the same layer as the transparent conductive film layer that is closest to the light emergent side.

4. The array substrate according to claim 2, wherein the array substrate comprises two or more transparent conductive film layers and the test unit is not formed in the same layer as the transparent conductive film layer that is closest to the light emergent side; the test unit is exposed through a via.

5. The array substrate according to claim 1, wherein the test unit is immediately adjacent to the test point.

6. The array substrate according to claim 1, wherein the test unit is connected to the test point through an electrical wire and/or a via.

7. The array substrate according to claim 6, wherein the via is located either at the test unit or at the test point.

8. The array substrate according to claim 6, wherein the electrical wire is of the same material as the test unit.

9. The array substrate according to claim 6, wherein the electrical wire is of the same material as the test point.

10. The array substrate according to claim 6, wherein the test unit, the electrical wire and the test point are of the same material.

11. The array substrate according to claim 1, wherein the array substrate further comprises a drive unit and the test unit is connected to the test point of the drive unit.

12. The array substrate according to claim 11, wherein the test point of the drive unit comprises a source, a drain, a gate, a gate line, and/or a data line.

13. The array substrate according to claim 1, wherein the test unit is connected to the test point of a signal line in the display region of the array substrate.

14. The array substrate according to claim 13, wherein the test point of the signal line comprises a gate, a source, a drain, a gate line, a gate line lead, a data line, and/or combinations thereof.

15. A display device comprising the array substrate of claim 1.
